(19) United States
(12) Patent Application Publication
(10) Pub. No.: US 2026/0320212 A1
(43) Pub. Date: Oct. 15, 2026

(54) Defining and Utilizing Data Loss Prevention (DLP) Sub-Dictionaries

(71) Applicant: Zscaler, Inc., San Jose, CA (US)

(72) Inventors: Zhifeng Zhang, Burnaby (CA); Arun Bhallamudi, San Jose, CA (US); Naba Chinde, Burnaby (CA); Vinh Tran, San Jose, CA (US)

(73) Assignee: Zscaler, Inc., San Jose, CA (US)

(21) Appl. No.: 19/179,892

(22) Filed: Apr. 15, 2025

(51) Int. Cl. G06F 21/62

(52) U.S. Cl. CPC G06F 21/6218

(57) ABSTRACT

Systems and methods for defining and utilizing DLP sub-dictionaries include monitoring network traffic associated with one or more tenants of a plurality of tenants of a cloud-based system; identifying a document in transit based on the monitoring of network traffic; identifying, based on one or more DLP dictionary weights, at least one parent dictionary and at least one corresponding sub-dictionary to be searched; matching contents of the document against data patterns or phrases defined in the identified sub-dictionary; and triggering an alert or a policy action if at least one matched data pattern or phrase exceeds a predefined threshold determined in part by the one or more DLP dictionary weights.

### FIELD OF THE DISCLOSURE

The present disclosure relates generally to networking and computing. More particularly, the present disclosure relates to systems and methods for defining and utilizing DLP sub-dictionaries.

### BACKGROUND OF THE DISCLOSURE

Conventional Data Loss Prevention (DLP) solutions often rely on flat dictionary structures or lightly implemented hierarchies, imposing strict limits on the number of dictionaries and incurring high memory usage. This is particularly problematic for organizations that require numerous custom dictionaries, each containing only a few patterns or phrases. Merely increasing the number of dictionaries exacerbates the system's memory consumption due to large, underutilized arrays storing weights and attributes for each phrase. Existing solutions fail to address both the capacity and memory challenges simultaneously, prompting a need for a more efficient, scalable approach. The present invention addresses these limitations by introducing a truly hierarchical dictionary architecture with a global weight table, enabling expanded dictionary capacity and improved memory optimization for modern DLP environments.

### BRIEF SUMMARY OF THE DISCLOSURE

The present disclosure relates to systems and methods for defining and utilizing DLP sub-dictionaries. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring network traffic associated with one or more tenants of a plurality of tenants of a cloud-based system; identifying a document in transit based on the monitoring of network traffic; identifying, based on one or more DLP dictionary weights, at least one parent dictionary and at least one corresponding sub-dictionary to be searched; matching contents of the document against data patterns or phrases defined in the identified sub-dictionary; and triggering an alert or a policy action if at least one matched data pattern or phrase exceeds a predefined threshold determined in part by the one or more DLP dictionary weights.

The steps can further include configuring a plurality of top-level parent dictionaries within a DLP system; creating, for at least one of the parent dictionaries, one or more sub-dictionaries each associated with a subset of data patterns or phrases; storing the parent dictionaries and the sub-dictionaries in a hierarchical data structure such that each sub-dictionary is referenced by a corresponding parent dictionary; and assigning weights to at least one of the parent dictionaries, the sub-dictionaries, or individual data patterns or phrases, wherein the weights reflect a priority or importance level for DLP scanning. The steps can include externalizing weight information for at least a portion of the data patterns or phrases into a global weight table, such that each data pattern or phrase maintains a reference to the global weight table. The steps can include dynamically adjusting one or more weights within the global weight table based on usage metrics or changing compliance requirements, and updating the scanning process accordingly without reconstructing the entire dictionary array for each data pattern or phrase storing the parent dictionaries and sub-dictionaries in the hierarchical data structure can include minimizing memory usage by reusing common data structures or references for identical data patterns or phrases shared across multiple dictionaries. The steps can include prioritizing sub-dictionaries based on their assigned weights, loading only the data patterns or phrases from the highest-weighted sub-dictionaries first to optimize both scanning speed and memory utilization. The steps can include receiving a request from a user to create a new sub-dictionary under an existing parent dictionary; allocating memory for the sub-dictionary and updating a hierarchical data structure to reference the sub-dictionary; and allowing the user to add one or more data patterns or phrases to the new sub-dictionary, each having an associated weight stored in a global weight table.

### BRIEF DESCRIPTION OF THE DRAWINGS

The present disclosure is detailed through various drawings, where like components or steps are indicated by identical reference numbers for clarity and consistency.

FIG. 1 is a flow diagram of a cloud-based DLP system.

FIG. 2 is a flowchart of a process for generating and utilizing DLP sub-dictionaries.

FIG. 3 is a block diagram of a server, which may be used as a destination on the Internet, for the cloud-based system, etc.

FIG. 4 is a block diagram of a computing device, which may be realize an endpoint.

### DETAILED DESCRIPTION OF THE DISCLOSURE

Again, the present disclosure relates to systems and methods for defining and utilizing DLP sub-dictionaries. Various embodiments introduce a hierarchical dictionary structure and a global weight table in a Data Loss Prevention (DLP) system. By allowing multiple sub-dictionaries to be nested under each parent dictionary, the invention overcomes the inherent limit of top-level dictionaries (e.g., 1,023) while significantly improving memory efficiency. Instead of maintaining a large, mostly empty array of weights for every phrase across all dictionaries, each phrase references a centralized weight table. This decoupled architecture reduces overall memory consumption, enables precise and dynamic priority weighting, and provides a scalable solution for organizations needing extensive custom dictionaries. By grouping related patterns and phrases under parent dictionaries with sub-dictionaries, administrators can more intuitively manage and update DLP policies. This hierarchical approach not only expands capacity but also boosts performance, offering a future-proof method for managing sensitive data in large and complex environments.

### Data Loss Prevention (DLP)

Data Loss Prevention (DLP) refers to a set of tools and processes designed to protect sensitive information from being accessed, misused, or exfiltrated, whether accidentally or intentionally. The roots of DLP trace back to early content filtering technologies, which were primarily used to block specific file types or keywords. Over time, as regulations became more stringent and threats grew in sophistication, organizations demanded more advanced methods to detect, track, and control sensitive data. This led to modern DLP solutions that inspect data at rest, in motion, and in use, providing much broader visibility and control over an organization's information flows.

Protecting sensitive data is often a top priority, as most organizations handle various types of confidential information, such as financial records, intellectual property, or personal data. DLP helps identify and secure this data to prevent unauthorized disclosure. Another core driver is regulatory compliance, with mandates like Health Insurance Portability and Accountability Act (HIPAA), Payment Card Industry Data Security Standard (PCI DSS), General Data Protection Regulation (GDPR), and California Consumer Privacy Act (CCPA) imposing strict requirements on how sensitive data is stored, handled, and shared. Noncompliance can result in significant fines or legal consequences, making DLP essential for organizations that must adhere to these laws. DLP is also instrumental in preventing insider threats, as data breaches or leaks can sometimes originate from within an organization, whether through malicious intent or human error. Additionally, maintaining brand reputation is a major concern, given that a data breach can severely damage trust among customers, partners, and the public.

DLP solutions begin by identifying sensitive data through various detection techniques, such as keyword searches, pattern matching (for Social Security numbers or credit card formats), dictionaries, and Exact Data Match (EDM). These solutions also monitor data in motion, inspecting network traffic (emails, file transfers, web uploads) in real time. If a match is detected, the system can block the transmission, quarantine it, or alert an administrator. Beyond data in motion, DLP scanners also control data at rest by searching file repositories, databases, and storage systems for regulated or sensitive information, then applying encryption or access controls as necessary. Some solutions extend this oversight to data in use, watching how users interact with protected data on endpoints, detecting, for instance, attempts to copy sensitive information to a device or a cloud service. DLP policies themselves are highly customizable, allowing organizations to tailor them to their specific compliance requirements and risk profile.

Many organizations implement DLP to comply with sector-specific or regional regulations. Under HIPAA, for example, healthcare providers and partners must protect Protected Health Information (PHI), and DLP solutions can identify PHI being emailed or uploaded outside permitted systems, enforcing encryption or blocking transmission as needed. In the payment card industry, PCI DSS dictates strict controls for handling payment card data, which DLP can enforce by flagging or blocking unencrypted card numbers in unauthorized channels. For the European Union's GDPR, DLP helps organizations discover personal data across systems, protect it from unauthorized access, and maintain detailed audit trails, all of which can be crucial in demonstrating compliance. Similarly, CCPA focuses on protecting personal data for California residents, and DLP tools identify and safeguard Personally Identifiable Information (PII) to help meet those requirements.

A primary benefit is risk reduction. By identifying and blocking sensitive data in real time, organizations minimize the likelihood of accidental or malicious data leaks. DLP also supports compliance and audit readiness, as logs and reports provide clear evidence of proper data handling practices. Beyond that, some DLP implementations include user education and accountability features, warning employees when a policy might be violated and thereby fostering a culture of heightened security awareness. Finally, incident response becomes more efficient, as detailed DLP alerts offer insights into the nature of policy violations and help security teams quickly investigate and address issues.

DLP has evolved into a strategic security pillar that monitors and protects sensitive data wherever it resides or travels. By integrating content inspection, real-time analytics, and robust policy enforcement, organizations can maintain regulatory compliance, deter insider threats, and safeguard their most valuable information assets. Whether deployed on-premises or through cloud-based platforms, DLP's overarching goal is to reduce the risk of data exposure, preserve user privacy, and uphold enterprise security standards in an increasingly data-driven world.

### DLP Dictionaries

DLP dictionaries are a foundational element of DLP solutions, serving as organized collections of keywords, patterns, and expressions that help identify sensitive or regulated information. Early DLP efforts focused on simple content filtering for certain file types or keywords, but as threats evolved and regulations became more stringent, dictionaries expanded to include sophisticated techniques for detecting a wide range of data formats. Today, they work by scanning data at rest, in motion, or in use, triggering alerts and enforcement actions whenever content matches specified criteria. This helps organizations prevent unauthorized disclosures, address insider threats, and meet compliance mandates.

A typical DLP dictionary includes both simple and complex elements. It may contain straightforward keywords or phrases, such as “confidential” or “internal use only,” as well as more intricate regex-based patterns for detecting things like credit card numbers, social security numbers, or medical codes. These patterns are often combined with contextual rules, which consider factors like surrounding text or the proximity of certain terms, to increase accuracy and reduce false positives. Thresholds also play a significant role, meaning administrators can decide how many keyword or pattern hits must occur before the system regards a piece of content as a potential violation.

Many DLP solutions come with industry-specific dictionaries covering domains such as healthcare, finance, and legal, ensuring that organizations can quickly align their security policies with relevant regulations. Regulatory dictionaries focus on data formats governed by specific laws, for example, detecting unencrypted cardholder data for PCI DSS or personal health information for HIPAA. Companies also frequently develop custom dictionaries to monitor internal project codes, intellectual property, or proprietary terms. EDM complements these dictionaries by relying on secure, hashed data sets that confirm an exact match without storing sensitive information in clear text.

Once configured, dictionaries operate in various scenarios. Inline network inspection involves analyzing data in real time whenever users send emails or upload files to the web, while at-rest scanning systematically searches file repositories or databases to locate any improperly stored data. Some DLP tools also monitor endpoint activity to detect risky behavior, such as copying confidential files to external drives or printing documents containing regulated data. Depending on the severity of a match, the system can block the action, issue a warning, quarantine the content, or merely log the incident for future reference.

Managing DLP dictionaries effectively requires ongoing attention. Regular updates ensure that they remain aligned with changing regulations, business processes, and new data formats. Because overly broad keywords can generate excessive false positives, tuning and testing dictionaries beforehand is essential. Strong role-based access control should also be in place, limiting who can modify the dictionaries or view details about sensitive detections. Finally, thorough documentation of the logic behind each dictionary entry makes it easier for compliance teams and administrators to understand what the system is looking for and why.

### Cloud-Based DLP

Cloud-based security solutions, such as the Zscaler cloud offered by Zscaler, the applicant and assignee of the present application, adopt a multi-tenant architecture where multiple customers (tenants) share common infrastructure resources (e.g., servers, networking), yet each tenant's data and policies remain isolated and secure. This architecture removes the need for on-premises hardware or extensive software deployments, reducing complexity and cost.

A cloud-based DLP service inspects data in transit (e.g., web traffic, email, file uploads) or at rest (e.g., data stored in cloud applications) to detect sensitive information. By integrating DLP controls into a larger suite of cloud security offerings (e.g., Secure Web Gateway, Cloud Firewall, CASB), the solution delivers a consistent policy enforcement experience for end users and administrators.

Benefits of cloud-based DLP include the ability of the service to scale automatically with changes in traffic volume or user count, eliminating the need for manual hardware upgrades, traffic is scanned in real time (including decryption of SSL/TLS traffic if configured) to detect policy violations before they leave the organization, and with points of presence (data centers) around the world, the same DLP policies apply to all users regardless of location.

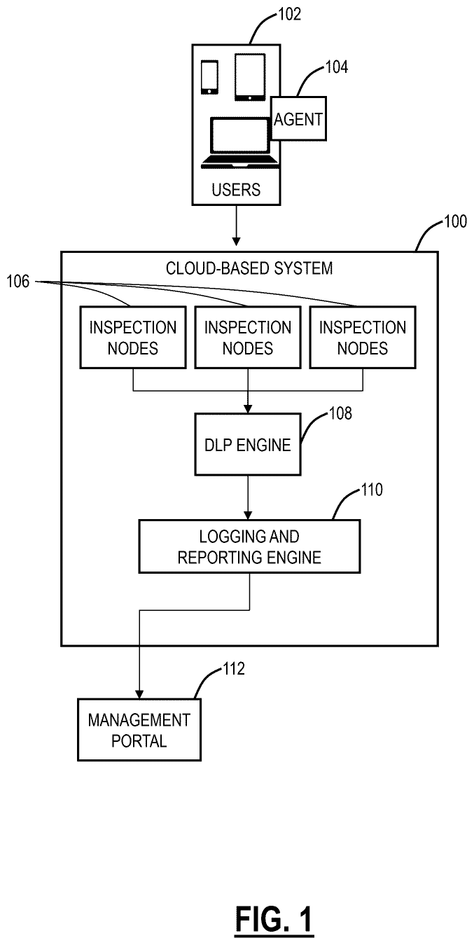

FIG. 1 is a flow diagram of a cloud-based DLP system. An example workflow that the described cloud-based DLP system, via a DLP engine 108, can follow to inspect user 102 traffic and enforce policies includes the following. First, during traffic redirection and Secure Socket Layer (SSL) inspection, organizations configure their endpoints, whether on-premises networks or remote devices, to forward web and other traffic to the cloud-based system 100. This forwarding can be accomplished using Virtual Private Network (VPN) tunnels, proxy settings, or lightweight endpoint agents 104. Once traffic is routed, the system directs it to the nearest data center to minimize latency. If SSL or Transport Layer Security (TLS) decryption is enabled, the service can decrypt and re-encrypt encrypted traffic, using certificates trusted by the organization, to perform content inspection on Hypertext Transfer Protocol Secure (HTTPS) connections.

Next, policy evaluation takes place. Each organization sets up tenant-specific DLP policies tailored to detect particular data patterns, dictionaries, keywords, or exact data matches, which may include requirements around proprietary information. Administrators can further specify contextual conditions, such as thresholds for the number of social security numbers in a file, to control when a violation is triggered. Based on these detections, different remediation actions (block, allow with warning, alert, or quarantine) are defined, guiding how the system responds to a violation.

During data inspection, traffic passing through the cloud's inspection nodes 106 is analyzed in real time. The DLP system extracts relevant text from uploads, email attachments, and web form submissions, comparing them against the organization's DLP rules. This comparison may involve pattern matching, dictionary lookups, or other detection techniques to identify regulated data such as credit card numbers or social security numbers. An optional feature, known as Exact Data Match (EDM), allows the secure upload of hashed sensitive data; the system flags violations if the traffic content matches these hashed entries, without storing the data in plain text.

In policy enforcement, once the DLP engine 108 detects a policy violation, the transaction is flagged. Depending on how the policies are configured, the system can block traffic and display a violation notification, allow the activity but warn the user or administrator, quarantine data for further inspection or encryption, or simply allow the activity while logging it for future auditing. Some advanced setups also enable automated responses such as encrypting emails or integrating with other platforms for incident response.

Finally, a logging and reporting engine 110 ensures full visibility of DLP activities. The system collects real-time logs of traffic events, including any DLP matches. Administrators can view incident details, when they occurred, who triggered them, and which rule was violated, through a console or portal. Dashboard analytics provide insights into trends, common violations, and user behaviors, and logs can be forwarded to a Security Information and Event Management (SIEM) solution for more in-depth correlation and forensic analysis.

Key components of the cloud-based DLP process and how they function are further described below. Inspection nodes 106 are the cloud-based gateways located in the provider's (for example Zscaler) data centers, where real-time data-plane inspection takes place. These nodes 106 apply DLP, and possibly other security measures, inline, examining traffic for sensitive information as it passes through. To ensure reliability and manage large volumes of traffic, the service often distributes these inspection tasks across multiple nodes, providing load balancing and maintaining high availability.

At the core of this process is the DLP engine 108, which functions as the policy enforcement core. It compares traffic contents against configured DLP rules, dictionaries, or EDM sets. Advanced detection methods, such as machine learning classifiers, heuristic analysis, and standard pattern matching, may be employed to identify sensitive information accurately and minimize false positives.

A management portal 112 or control plane centralizes policy configuration and administration. Through this portal, administrators can define or update rules, permissions, and user groups. Whenever changes occur, they are quickly pushed out to all inspection nodes, ensuring consistent enforcement of DLP policies across the entire network.

To keep track of incidents and ensure comprehensive oversight, a logging and reporting engine 110 collects transaction logs and DLP incident data in near real time using an efficient, high-speed logging framework. Administrators then rely on built-in analytical tools to visualize trends, generate detailed compliance and security reports, and conduct forensic investigations when necessary through the management portal 112.

Finally, an endpoint agent 104, though optional, can be installed on user devices to direct all traffic to the cloud-based system 100. This ensures consistent application of DLP policies, whether a user 102 is working within the corporate network or remotely. By forwarding all traffic through the cloud-based service, organizations maintain uniform data protection policies regardless of a user's 102 location.

### DLP Sub-Dictionaries

The current disclosure provides systems and methods to solve two significant challenges faced by contemporary DLP solutions. Firstly, it aims to enhance the limited utilization of hierarchical dictionaries available to customers. These dictionaries are essential for effectively categorizing and managing data, and their restricted use can hinder the overall efficiency and accuracy of DLP systems. Secondly, the disclosure addresses the issue of excessive memory consumption, which poses a substantial burden on engineering resources. By optimizing memory usage, the solution can improve performance and scalability, making it more practical and cost-effective for broader deployment. In essence, this disclosure proposes innovative approaches to improve both the customer experience and the technical efficiency of DLP solutions.

In the current landscape of DLP solutions, dictionaries are organized in a flat list format, permitting up to 1023 dictionaries. Although hierarchical dictionary features have been introduced, allowing each dictionary to include up to 64 “identifiers,” this structure is not genuinely hierarchical. The term “identifier” functions more as a label rather than a comprehensive dictionary that can encapsulate other objects like patterns and phrases. As a result, these hierarchical dictionaries with identifiers are only effective for certain data types, such as passports and driver's licenses, which are inherently identifiers. However, they fall short in versatility for broader, more general use cases.

When the capacity for supported dictionaries was expanded from 64 to 1023, it was anticipated that it would be a sufficient solution for the foreseeable future. Unfortunately, this assumption has proven to be incorrect. Presently, customers of the cloud-based system 100 have unique requirements necessitating the tracking of a large number of custom dictionaries, each containing only a few patterns or phrases. These customers demand a capacity exceeding the current limit of 1023 dictionaries.

Addressing this issue is not as simple as doubling the current limit, as this approach would lead to exponentially increased memory consumption. Instead, a fundamental redesign of how phrases, patterns, and dictionaries are stored and managed is necessary. This redesign aims to enhance efficiency and scalability, ensuring that the system can accommodate the growing and diverse needs of customers without incurring prohibitive memory usage. By rethinking the storage and management architecture, we can create a more robust and adaptable DLP solution capable of meeting future demands.

Phrase and pattern objects significantly contribute to the static memory usage of a company's DLP configuration objects. Currently, there are 142,512 phrases associated with predefined dictionaries. Each phrase requires 1,232 bytes of memory storage, resulting in a total memory consumption of 167 MB solely for predefined phrases. Moreover, the memory usage for phrases in custom dictionaries scales proportionally with the number of phrases each customer configures.

As the cloud-based system 100 continues to support an increasing number of dictionaries, the memory footprint associated with these phrases and patterns will inevitably grow. This escalating memory consumption poses a challenge that needs to be addressed proactively. Without optimization, the memory requirements could become unmanageable, potentially affecting the performance and scalability of DLP solutions. Therefore, it is imperative to reassess and refine the current approach to memory management for phrases and patterns, ensuring that systems can support an expanding repertoire of dictionaries efficiently and sustainably. By optimizing memory usage now, we can safeguard against future issues and maintain the robustness of our DLP offerings.

Building on this understanding, the present solution introduces the concept of sub-dictionaries to address the issue of limited dictionary space while simultaneously optimizing memory usage through newly designed data structures. At a high level, this innovative approach enables customers to group a collection of similar or related dictionaries under a single parent dictionary.

While the system will continue to support the 1,023 top-level dictionaries, the inclusion of sub-dictionaries effectively expands the total number of supported dictionaries to a significantly larger number. This hierarchical approach not only alleviates the constraints on dictionary space but also enhances the overall efficiency of memory usage. By organizing dictionaries into parent-child relationships, the system can manage memory more effectively and provide a scalable solution that can accommodate the growing and diverse needs of customers.

This solution offers a sustainable and future-proof method for dictionary management in DLP systems. By allowing sub-dictionaries, the present systems ensure that the cloud-based system 100 remains robust and adaptable, capable of supporting an ever-increasing number of dictionaries without compromising on performance or memory efficiency.

Again, the new sub-dictionaries feature is specifically designed to tackle two major challenges: limited dictionary space and the need for optimized memory usage. By introducing a hierarchical structure for dictionaries, this feature provides a more scalable and efficient approach to managing extensive sets of data patterns and phrases.

One of the core components of this feature is the concept of parent and sub-dictionaries. The parent dictionary acts as a top-level container for related sub-dictionaries, allowing for the logical grouping of similar or related data patterns and phrases. Sub-dictionaries, nested under a parent dictionary, enable a more granular and manageable organization of data, which facilitates easier updates and maintenance.

The hierarchical structure allows for the organization of dictionaries in a tree-like format, which is more intuitive and mirrors real-world data organization. This makes it easier for customers to manage their data loss prevention rules. While the system continues to support 1,023 top-level (parent) dictionaries, the introduction of sub-dictionaries significantly increases the total number of dictionaries that can be managed, effectively overcoming previous limitations.

The new feature brings several benefits. First, it increases capacity by allowing sub-dictionaries meaning the total number of supported dictionaries expands beyond the previous limit of 1,023. This expansion meets the growing demands of customers who require extensive custom dictionaries, each containing a limited number of patterns or phrases.

Second, it optimizes memory usage. The implementation of newly designed data structures for sub-dictionaries ensures more efficient memory usage. This is crucial as it prevents exponential growth in memory consumption, which would otherwise occur if the dictionary limit were simply increased without structural changes. Memory optimization is achieved through a more compact representation of phrases and patterns within the hierarchical model, reducing the overall memory footprint.

Third, it enhances organization and management. Grouping related dictionaries under a parent dictionary simplifies the organization and retrieval of data. This logical grouping makes it easier for administrators to manage and update DLP configurations. The hierarchical structure supports better indexing and faster search capabilities, improving the performance of DLP operations.

Finally, it is a future-proof solution. This scalable approach ensures that our DLP solution can accommodate future growth in customer needs without requiring frequent overhauls or hitting arbitrary limits. The flexibility provided by sub-dictionaries positions the system to handle an indefinite increase in dictionary numbers.

This feature is particularly beneficial for large enterprises, industry-specific regulations, and multi-national corporations. Enterprises with complex data protection needs can create extensive and detailed DLP policies. For example, a financial institution, which needs to track a large number of custom dictionaries, can now do so efficiently without worrying about hitting the dictionary limit.

Different industries have unique data protection requirements. For instance, healthcare organizations can group dictionaries related to various types of patient information under relevant parent dictionaries, ensuring compliance with regulations like HIPAA. Companies operating in multiple regions can organize dictionaries specific to each region or country under parent dictionaries, facilitating compliance with local data protection laws.

The implementation of this feature involves several technical enhancements. The new data structures are designed to minimize redundancy and enhance memory efficiency. Phrases and patterns are stored in a way that leverages shared components where possible, reducing the overall memory required for storage.

The DLP configuration interface/portal has been updated to support the creation and management of sub-dictionaries. Administrators can easily navigate through the hierarchical structure, add new sub-dictionaries, and assign phrases and patterns to the appropriate levels.

Existing dictionaries are seamlessly integrated into the new structure. Customers currently using flat dictionaries can transition to the hierarchical model without losing any data or having to reconfigure their DLP policies extensively. The hierarchical organization allows for more efficient indexing and retrieval algorithms, resulting in faster performance for DLP operations such as policy enforcement and data scanning.

Additionally, the present invention optimizes the utilization of weights associated with DLP dictionaries, phrases, etc. At the parent dictionary level, weights can be assigned to indicate the overall importance of the entire dictionary. This weight influences how the system prioritizes the evaluation of patterns within this dictionary relative to others. Within each parent dictionary, sub-dictionaries can also have weights assigned to them. These weights help in prioritizing which sub-dictionaries should be evaluated first when multiple sub-dictionaries exist under a single parent dictionary.

Each phrase or pattern within a sub-dictionary can have its own weight. This granular weighting allows for fine-tuned control over the significance of individual data patterns. Higher-weighted patterns are given more importance during the evaluation process. Additionally, the weights of individual phrases and patterns can be dynamically adjusted based on the context or the evolving needs of the organization's data protection strategy.

The system can compute cumulative weights by taking into account the weights assigned at the parent dictionary, sub-dictionary, and individual pattern levels. This hierarchical weighting ensures that the evaluation process is both comprehensive and contextually aware. Weights assigned at higher levels (parent or sub-dictionary) can influence the weighting of individual patterns within those dictionaries. For example, a high-weighted parent dictionary can boost the significance of all its contained sub-dictionaries and their patterns.

During data scanning and evaluation, the system uses these weights to prioritize which patterns to check first. Patterns with higher cumulative weights are evaluated before those with lower weights, ensuring that the most critical data patterns are scrutinized first. The system can set thresholds based on weights to determine which patterns trigger alerts or actions. Higher-weighted patterns might have lower thresholds for action, reflecting their greater importance in the DLP strategy.

By incorporating weights into the hierarchical structure, the system can optimize memory usage. It avoids unnecessary evaluation of low-weight patterns by focusing resources on more critical patterns. This prioritization facilitated by weights ensures that the DLP system operates efficiently, with faster response times for detecting and preventing data loss incidents.

In an example workflow, suppose an administrator sets up a parent dictionary for financial data with a high weight due to its critical nature. Under this parent dictionary, sub-dictionaries for different types of financial documents (e.g., “Bank Statements,” “Credit Reports”) are created, each with its own weight. Individual phrases within these sub-dictionaries are assigned specific weights based on their importance. For instance, phrases related to account numbers might receive higher weights. During operation, the DLP system scans data and prioritizes the evaluation of high-weighted parent dictionaries, followed by their sub-dictionaries and individual phrases. Patterns with higher cumulative weights are checked first. If a high-weighted pattern is detected, the system can trigger immediate alerts or actions, reflecting the pattern's critical importance.

Furthermore, specific phrases can be included in multiple DLP dictionaries, each with different weights assigned to them. This variability can complicate determining the correct weight to assign to a phrase based on current DLP monitoring. Currently, DLP systems utilize an array for each phrase to define its weights across different dictionaries. Consequently, for every phrase, there is an array sized to match the number of dictionaries, such as 1023 in many cases. This structure remains fixed even if the phrase is assigned to only a single dictionary. This approach is inefficient because the system still requires an array with 1023 elements to define the weights of a phrase that may only be assigned to one dictionary.

For example, consider predefined dictionaries like financial and medical DLP dictionaries, which contain 142,512 phrases. Each of these phrases takes up 1,232 bytes of memory storage, meaning that predefined phrases alone consume 167 MB of memory space. If traditional methods are used and additional dictionaries are required, the weight array for each phrase will expand, even though these arrays will be mostly empty, up to 99% in many cases.

To address this inefficiency, the present solution externalizes the weight information of each phrase into a separate object. This is achieved through the implementation of a new weight table, where each phrase has an element representing its weight across different dictionaries. By decoupling the weight information from the phrases themselves and storing it in a centralized weight table, the system can significantly reduce memory usage. Instead of maintaining large, mostly empty arrays for each phrase, the weight table allows for a more dynamic and efficient representation of weight information. This approach not only optimizes memory usage but also simplifies the management and retrieval of weight data, enhancing the overall performance and scalability of the DLP system.

In an example, suppose the phrase “word” is included in dictionary 1 and dictionary 2 and has a weight of 2 in dictionary 1 and a weight of 3 in dictionary 2. The traditional phrase expression to define this phrase would include the following:
Phrase: word
Weights: [2, 3, 0, 0, 0, 0, 0, . . . ]

Again, the weights element includes an array sized to match the number of dictionaries. With the present solution, the phrase expression does not include the weights element. Alternatively, there exists a global weights table which is dynamically allocated. Based thereon, the phrase expression includes a start index element and a number of weights element, which in this case would be 2 weights and a start index of 0. This can be represented as follows.
Phrase: Word
Start Index: 0
Number of Weights: 2

Based thereon, during monitoring, the system will know that this phrase is included in 2 dictionaries and can retrieve the weights associated therewith based on the index and number of weights elements. The global weights table for this phrase can be represented as follows.
Weight Table:
Weight {
   Dictionary ID: 1
   Weight: 2
   }
Weight {
   Dictionary ID: 2
   Weight: 3
   }
. . .

When utilizing the sub-directory feature, the DLP system follows a series of well-defined steps to scan a document effectively, leveraging the hierarchical structure of parent and sub-directories to optimize scanning efficiency and accuracy. The process begins with initialization and configuration, where the DLP system loads its configuration settings, including the hierarchical structure and associated weights for each dictionary and pattern. The scope of the document scan is determined based on the configured DLP policies and the type of document being scanned.

Next, responsive to identifying a document based on performing monitoring of a customers network via the cloud-based system, the document undergoes preprocessing, which involves parsing the document to extract text and relevant data elements, potentially converting it into a machine-readable format. The extracted text is then normalized by removing special characters, converting text to a consistent case, and tokenizing words and phrases.

Following preprocessing, the system identifies relevant parent dictionaries based on the document type and DLP policies. Within each selected parent dictionary, sub-directories are prioritized according to their assigned weights, with higher-weighted sub-directories given precedence in the scanning process.

During the pattern matching phase, the system loads the necessary patterns and phrases from the prioritized sub-directories into memory, minimizing memory usage by only loading what is required. The document text is then scanned against these loaded patterns using efficient pattern matching methods to identify any occurrences of sensitive data.

The system then calculates the cumulative weights for each detected pattern by considering the weights assigned at the parent dictionary, sub-directory, and individual pattern/phrase levels. These cumulative weights are compared against predefined thresholds to determine the severity and relevance of the detections, with patterns exceeding the thresholds triggering alerts or actions.

In the action and reporting phase, the system triggers appropriate actions based on the severity and relevance of the detected patterns, which may include blocking the document, alerting administrators, or logging the incident. Detailed reports are generated, outlining the detected patterns, their weights, and the actions taken, providing administrators with insights into the nature of the detected sensitive data and the effectiveness of the DLP policies.

Post-scan activities involve updating the system logs with the scan results, including any detected patterns, actions taken, and the document's disposition. If necessary, the system uses the scan results to update and refine the DLP policies and weight assignments, ensuring continuous improvement in detection accuracy and efficiency.

For example, during the initialization phase, the DLP system may identify relevant parent dictionaries like “Financial Data” and their sub-directories such as “Bank Statements” and “Credit Reports.” During preprocessing, the document is parsed and normalized. The system then prioritizes the sub-directories based on their weights, choosing to scan the “Bank Statements” sub-directory first due to its higher weight. Patterns from this sub-directory are loaded, and the document text is scanned for matches. Detected patterns are evaluated, and their cumulative weights are computed, with patterns exceeding the thresholds triggering alerts. The system blocks the document and generates a report detailing the detected patterns and actions taken. Finally, the logs are updated, and the scan results are used to refine future DLP policies.

By following these steps, the DLP system efficiently scans documents utilizing the sub-directory feature, ensuring that sensitive data is accurately detected and appropriately managed while optimizing memory usage and system performance.

In another embodiment, the hierarchical dictionary structure and global weight table may be distributed across multiple computing nodes to further optimize performance and memory utilization in large-scale or high-throughput environments. In this distributed model, each node is responsible for storing and managing a subset of parent dictionaries, sub-dictionaries, and the associated weight data. The system also includes a centralized or coordinated index service, such as a load balancer or orchestration layer, that keeps track of which node holds which dictionaries.

In this design, when a document or data stream requires scanning, the coordination layer evaluates the relevant parent dictionaries, identifies the node or nodes responsible for the corresponding sub-dictionaries, and routes the scanning request accordingly. Since each node only loads and processes the dictionaries under its purview, overall memory usage per node is reduced. The global weight table is also partitioned or sharded among the nodes; each phrase or pattern references the appropriate entry within the local partition of the table. If multiple dictionaries (located on different nodes) need to be scanned, the system can merge the partial results once each node completes its local scan, aggregating detections and weighting information at the coordination layer.

This embodiment can optionally support ephemeral sub-dictionaries, which are dynamically created and only persist for a defined time period or until a particular scanning task is complete. For instance, an administrator might generate a temporary sub-dictionary for a specific compliance audit, uploading time-limited patterns and phrases. After the audit concludes, the system automatically expires the ephemeral sub-dictionary, freeing memory and reducing long-term maintenance overhead. Ephemeral sub-dictionaries can share references to the same global weight table structure, allowing them to be integrated with existing weighting and priority logic without incurring the cost of large, dedicated weight arrays.

By distributing both the dictionary content and the weight references across multiple nodes, this embodiment provides a more scalable solution for enterprises with high data volumes or geographically dispersed data centers. The hierarchical relationships—parent dictionary to sub-dictionary—remain intact, but each node only manages a fraction of the overall hierarchy. This approach preserves the benefits of sub-dictionaries and global weight tables, such as reduced memory footprints and flexible, fine-grained policy enforcement, while further improving throughput, fault tolerance, and scalability in cloud-based or multi-data-center deployments.

### Process for Generating and Utilizing DLP Sub-Dictionaries

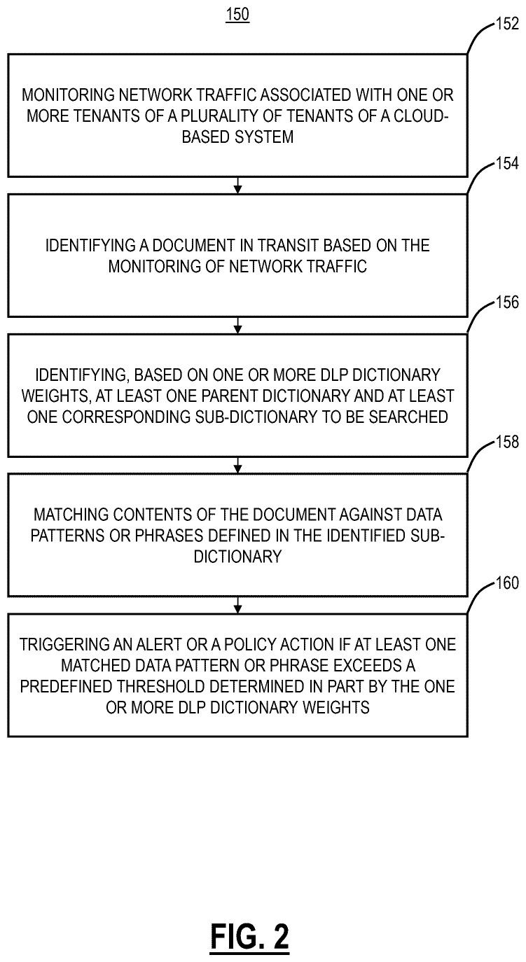

FIG. 2 is a flowchart of a process 150 for generating and utilizing DLP sub-dictionaries. In various embodiments, the process 150 can be contemplated as a method having steps, a processing device configured to implement the steps, a cloud-based system configured to implement the steps, and as a non-transitory computer-readable medium storing instructions for programming one or more processors to execute the steps. The process 150 includes monitoring network traffic associated with one or more tenants of a plurality of tenants of a cloud-based system (step 152); identifying a document in transit based on the monitoring of network traffic (step 154); identifying, based on one or more DLP dictionary weights, at least one parent dictionary and at least one corresponding sub-dictionary to be searched (step 156); matching contents of the document against data patterns or phrases defined in the identified sub-dictionary (step 158); and triggering an alert or a policy action if at least one matched data pattern or phrase exceeds a predefined threshold determined in part by the one or more DLP dictionary weights (step 160).

The process 150 can further include configuring a plurality of top-level parent dictionaries within a DLP system; creating, for at least one of the parent dictionaries, one or more sub-dictionaries each associated with a subset of data patterns or phrases; storing the parent dictionaries and the sub-dictionaries in a hierarchical data structure such that each sub-dictionary is referenced by a corresponding parent dictionary; and assigning weights to at least one of the parent dictionaries, the sub-dictionaries, or individual data patterns or phrases, wherein the weights reflect a priority or importance level for DLP scanning. The steps can include externalizing weight information for at least a portion of the data patterns or phrases into a global weight table, such that each data pattern or phrase maintains a reference to the global weight table. The steps can include dynamically adjusting one or more weights within the global weight table based on usage metrics or changing compliance requirements, and updating the scanning process accordingly without reconstructing the entire dictionary array for each data pattern or phrase storing the parent dictionaries and sub-dictionaries in the hierarchical data structure can include minimizing memory usage by reusing common data structures or references for identical data patterns or phrases shared across multiple dictionaries. The steps can include prioritizing sub-dictionaries based on their assigned weights, loading only the data patterns or phrases from the highest-weighted sub-dictionaries first to optimize both scanning speed and memory utilization. The steps can include receiving a request from a user to create a new sub-dictionary under an existing parent dictionary; allocating memory for the sub-dictionary and updating a hierarchical data structure to reference the sub-dictionary; and allowing the user to add one or more data patterns or phrases to the new sub-dictionary, each having an associated weight stored in a global weight table.

### Example Server Architecture

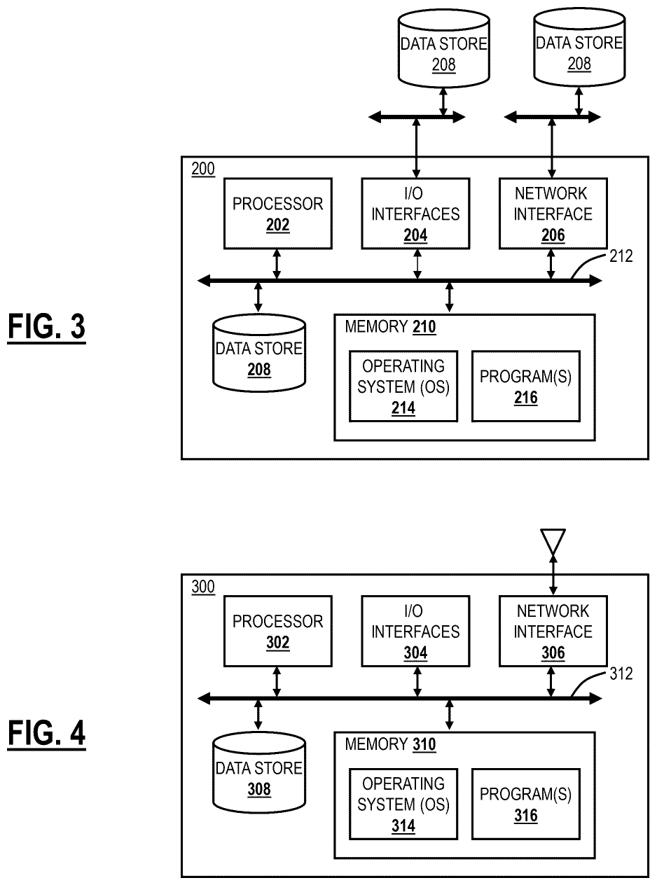

FIG. 3 is a block diagram of a server 200, which may be used as a destination on the Internet, for the cloud-based system 100, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud-based system 100 ultimately runs on one or more physical servers 200, virtual machines, etc.

### Example Computing Device Architecture

FIG. 4 is a block diagram of a computing device 300, which may be realize an endpoint. Specifically, the computing device 300 can form a device used by one of the endpoints, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 4 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 4, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The agent application 104 can be one of the example programs.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for performing Data Loss Prevention (DLP), the method comprising steps of:
monitoring network traffic associated with one or more tenants of a plurality of tenants of a cloud-based system;
identifying a document in transit based on the monitoring of network traffic;
identifying, based on one or more DLP dictionary weights, at least one parent dictionary and at least one corresponding sub-dictionary to be searched;
matching contents of the document against data patterns or phrases defined in the identified sub-dictionary; and
triggering an alert or a policy action if at least one matched data pattern or phrase exceeds a predefined threshold determined in part by the one or more DLP dictionary weights.

2. The method of claim 1, wherein the steps comprise:
configuring a plurality of top-level parent dictionaries within a DLP system;
creating, for at least one of the parent dictionaries, one or more sub-dictionaries each associated with a subset of data patterns or phrases;
storing the parent dictionaries and the sub-dictionaries in a hierarchical data structure such that each sub-dictionary is referenced by a corresponding parent dictionary; and
assigning weights to at least one of the parent dictionaries, the sub-dictionaries, or individual data patterns or phrases, wherein the weights reflect a priority or importance level for DLP scanning.

3. The method of claim 2, wherein the steps comprise externalizing weight information for at least a portion of the data patterns or phrases into a global weight table, such that each data pattern or phrase maintains a reference to the global weight table.

4. The method of claim 3, further comprising dynamically adjusting one or more weights within the global weight table based on usage metrics or changing compliance requirements.

5. The method of claim 2, wherein storing the parent dictionaries and sub-dictionaries in the hierarchical data structure further comprises minimizing memory usage by reusing common data structures or references for identical data patterns or phrases shared across multiple dictionaries.

6. The method of claim 1, wherein the steps include prioritizing sub-dictionaries based on their assigned weights, loading only the data patterns or phrases from highest-weighted sub-dictionaries first to optimize both scanning speed and memory utilization.

7. The method of claim 1, wherein the steps comprise:
receiving a request from a user to create a new sub-dictionary under an existing parent dictionary;
allocating memory for the sub-dictionary and updating a hierarchical data structure to reference the sub-dictionary; and
allowing the user to add one or more data patterns or phrases to the new sub-dictionary, each having an associated weight stored in a global weight table.

8. A non-transitory computer-readable storage medium having computer-readable code stored thereon for programming one or more processors to perform steps of:
monitoring network traffic associated with one or more tenants of a plurality of tenants of a cloud-based system;
identifying a document in transit based on the monitoring of network traffic;
identifying, based on one or more Data Loss Prevention (DLP) dictionary weights, at least one parent dictionary and at least one corresponding sub-dictionary to be searched;
matching contents of the document against data patterns or phrases defined in the identified sub-dictionary; and
triggering an alert or a policy action if at least one matched data pattern or phrase exceeds a predefined threshold determined in part by the one or more DLP dictionary weights.

9. The non-transitory computer-readable storage medium of claim 8, wherein the steps comprise:
configuring a plurality of top-level parent dictionaries within a DLP system;
creating, for at least one of the parent dictionaries, one or more sub-dictionaries each associated with a subset of data patterns or phrases;
storing the parent dictionaries and the sub-dictionaries in a hierarchical data structure such that each sub-dictionary is referenced by a corresponding parent dictionary; and
assigning weights to at least one of the parent dictionaries, the sub-dictionaries, or individual data patterns or phrases, wherein the weights reflect a priority or importance level for DLP scanning.

10. The non-transitory computer-readable storage medium of claim 9, wherein the steps comprise externalizing weight information for at least a portion of the data patterns or phrases into a global weight table, such that each data pattern or phrase maintains a reference to the global weight table.

11. The non-transitory computer-readable storage medium of claim 10, further comprising dynamically adjusting one or more weights within the global weight table based on usage metrics or changing compliance requirements.

12. The non-transitory computer-readable storage medium of claim 9, wherein storing the parent dictionaries and sub-dictionaries in the hierarchical data structure further comprises minimizing memory usage by reusing common data structures or references for identical data patterns or phrases shared across multiple dictionaries.

13. The non-transitory computer-readable storage medium of claim 8, wherein the steps include prioritizing sub-dictionaries based on their assigned weights, loading only the data patterns or phrases from highest-weighted sub-dictionaries first to optimize both scanning speed and memory utilization.

14. The non-transitory computer-readable storage medium of claim 8, wherein the steps comprise:
receiving a request from a user to create a new sub-dictionary under an existing parent dictionary;
allocating memory for the sub-dictionary and updating a hierarchical data structure to reference the sub-dictionary; and
allowing the user to add one or more data patterns or phrases to the new sub-dictionary, each having an associated weight stored in a global weight table.

15. A cloud-based system comprising:
one or more processors; and
memory storing computer-executable instructions that, when executed, cause the one or more processors to:
monitor network traffic associated with one or more tenants of a plurality of tenants of a cloud-based system;
identify a document in transit based on the monitoring of network traffic;
identify, based on one or more DLP dictionary weights, at least one parent dictionary and at least one corresponding sub-dictionary to be searched;
match contents of the document against data patterns or phrases defined in the identified sub-dictionary; and
trigger an alert or a policy action if at least one matched data pattern or phrase exceeds a predefined threshold determined in part by the one or more DLP dictionary weights.

16. The cloud-based system of claim 15, wherein the instructions further cause the one or more processors to:
configure a plurality of top-level parent dictionaries within a DLP system;
create, for at least one of the parent dictionaries, one or more sub-dictionaries each associated with a subset of data patterns or phrases;
store the parent dictionaries and the sub-dictionaries in a hierarchical data structure such that each sub-dictionary is referenced by a corresponding parent dictionary; and
assign weights to at least one of the parent dictionaries, the sub-dictionaries, or individual data patterns or phrases, wherein the weights reflect a priority or importance level for DLP scanning.

17. The cloud-based system of claim 16, wherein the wherein the instructions further cause the one or more processors to externalize weight information for at least a portion of the data patterns or phrases into a global weight table, such that each data pattern or phrase maintains a reference to the global weight table.

18. The cloud-based system of claim 17, further comprising dynamically adjusting one or more weights within the global weight table based on usage metrics or changing compliance requirements.

19. The cloud-based system of claim 16, wherein storing the parent dictionaries and sub-dictionaries in the hierarchical data structure further comprises minimizing memory usage by reusing common data structures or references for identical data patterns or phrases shared across multiple dictionaries.

20. The cloud-based system of claim 15, wherein the instructions further cause the one or more processors to prioritize sub-dictionaries based on their assigned weights, loading only the data patterns or phrases from highest-weighted sub-dictionaries first to optimize both scanning speed and memory utilization.
